(19) United States
(12) Patent Application Publication
(10) Pub. No.: US 2025/0095256 A1
(43) Pub. Date: Mar. 20, 2025

(54) IN-CONTEXT IMAGE GENERATION USING STYLE IMAGES

(71) Applicant: ADOBE INC., SAN JOSE, CA (US)

(72) Inventors: Vlad-Constantin Lungu-Stan, Bucuresti (RO); Marian Lupascu, Bucuresti (RO); Ionut Mironicä, Bucharest (RO)

(21) Appl. No.: 18/890,203

(22) Filed: Sep. 19, 2024

Related U.S. Application Data
(60) Provisional application No. 63/584,257, filed on Sep. 21, 2023.

(30) Foreign Application Priority Data
Sep. 20, 2023 (RO) A/00517/2023

(51) Int. Cl. G06T 11/60; G06T 7/11

(52) U.S. Cl. CPC G06T 11/60; G06T 7/11

(57) ABSTRACT

A method, apparatus, non-transitory computer readable medium, and system for generating images with a particular style that fit coherently into a scene includes obtaining a text prompt and a preliminary style image. The text prompt describes an image element, and the preliminary style image includes a region with a target style. Embodiments then extract the region with the target style from the preliminary style image to obtain a style image. Embodiments subsequently generate, using an image generation model, a synthetic image based on the text prompt and the style image. The synthetic image depicts the image element with the target style.

### CROSS-REFERENCE TO RELATED APPLICATION

This U.S. non-provisional application claims priority under 35 U.S.C. § 119 to U.S. Provisional Patent Application No. 63/584,257 filed on Sep. 21, 2023 in the United States Patent and Trademark Office, as well as to Romanian Patent Application A/00517/2023 filed on Sep. 20, 2023 in the State Office for Inventions and Trademarks (OSIM), the disclosures of which are incorporated by reference herein in their entirety.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. In some cases, users wish to generate images that conform to a style of their project. For example, users may wish to generate characters or objects that can be coherently composited into a scene. Additionally, users may wish to generate images that are easily converted to vector format images.

### SUMMARY

Embodiments of the present inventive concepts include systems and methods for generating synthetic images from a text prompt in the style of a style image. Users may wish to incorporate stylistic elements from a reference image without transferring additional elements, such as scenic elements, into their generated image. Embodiments include an image processing apparatus that identifies a region from a reference image (referred to herein as a “preliminary style image”) depicting a scene, and then uses the region to create a smaller style image for text-to-image generation. In some cases, the system automatically pads the region to form a border, resulting in a style image with content focused in the center of the image. The style image is then encoded along with the text prompt to provide guidance to an image generation model, which in turn generates a synthetic image. By using the region of the reference image as a style guide, embodiments generate synthetic images that are coherent and consistent with and can be easily inserted into the scene of the reference image.

A method, apparatus, non-transitory computer readable medium, and system for image generation are described. One or more aspects of the method, apparatus, non-transitory computer readable medium, and system include obtaining a text prompt and a preliminary style image, wherein the text prompt describes an image element and the preliminary style image includes a region with a target style; extracting the region with the target style from the preliminary style image to obtain a style image; and generating, using an image generation model, a synthetic image based on the text prompt and the style image, wherein the synthetic image depicts the image element with the target style.

An apparatus, method, non-transitory computer readable medium, and system for in-context image generation is described. One or more aspects of the apparatus, method, non-transitory computer readable medium, and system include a memory component; a processing device coupled to the memory component; an extraction component comprising parameters stored in the memory component and configured to extract a region with a target style from a preliminary style image to obtain a style image; and an image generation model comprising parameters stored in the memory component and trained to generate a synthetic image based on a text prompt and the style image, wherein the synthetic image depicts an image element from the text prompt with the target style.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of an image generation pipeline according to aspects of the present disclosure.

FIG. 6 shows an example of effects of different padding according to aspects of the present disclosure.

FIG. 7 shows an example of results of different style images combined with the same text prompt according to aspects of the present disclosure.

FIG. 8 shows an example of synthetic image placement according to aspects of the present disclosure.

FIG. 9 shows an example of placement of multiple synthetic images within a scene according to aspects of the present disclosure.

FIG. 10 shows an example of additional object placements according to aspects of the present disclosure.

FIG. 11 shows an example of a method for forward and reverse diffusion according to aspects of the present disclosure.

FIG. 12 shows an example of a method for generating synthetic images that are coherent with a preliminary style image according to aspects of the present disclosure.

FIG. 13 shows an example of a machine learning training algorithm according to aspects of the present disclosure.

FIG. 14 shows an example of a method for training a diffusion model according to aspects of the present disclosure.

FIG. 15 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

Some conventional approaches for text-to-image generation include Generative Adversarial Networks (GANs), which have demonstrated impressive performance in generating realistic images from text prompts. However, GANs face challenges such as training instability and poor generalizability. Recent advancements in diffusion models have shown promise in generating high-quality images from text prompts. The text-to-image diffusion models incorporate a pre-trained text encoder that is configured to generate a text embedding from an input text, and features of the text embedding are combined with the intermediate image features during image synthesis using cross-attention.

In some cases, users wish to add elements into their design compositions. This can involve drawing their own artwork from scratch, which can be time-consuming and resource-intensive. Recently, users have adapted generative models to assist in creating visual content for their designs.

When incorporating synthetic images into a larger composition, users often want to ensure that the new content fits seamlessly into the overall design. Coherence refers to how well the new content aligns with existing elements in terms of style, theme, and visual characteristics. Conventional approaches to image generation often focus on creating entire scenes or standalone images. However, these methods may not always produce results that can be readily incorporated into existing compositions. Users can face challenges in generating synthetic images that maintain visual consistency with the surrounding context.

Some existing techniques utilize generative inpainting to obtain assets that fit into a composition. However, this approach can inadvertently alter elements from the original image. Additionally, any generated assets often require careful extraction, which can be a complex and time-consuming process. There exist some style transfer techniques to apply a desired style to generated content. These approaches, however, frequently borrow too heavily from the content of the reference image rather than effectively capturing and transferring only the style elements. This can result in generated assets that do not adequately maintain their intended content while adopting the desired style.

Embodiments of the present inventive concepts improve the accuracy in style-conditioned text-to-image generation. Embodiments include an image processing apparatus that identifies a region from a preliminary style image depicting a scene. This region is used to create a smaller style image for text-to-image generation, which may be automatically padded to form a border. The style image is encoded along with a text prompt to guide an image generation model in producing a synthetic image.

Embodiments include a segmentation component that can automatically find regions that are semantically similar to the text prompt or most appropriate for inserting the generated synthetic images. Further, the embodiments enable more accurate vectorization processes by extracting a style image from an already vectorizable preliminary style image. By using the region of the reference image as a style guide, the system generates synthetic images that are coherent and consistent with the scene of the reference image and facilitate easy insertion of the generated content to form coherent compositions.

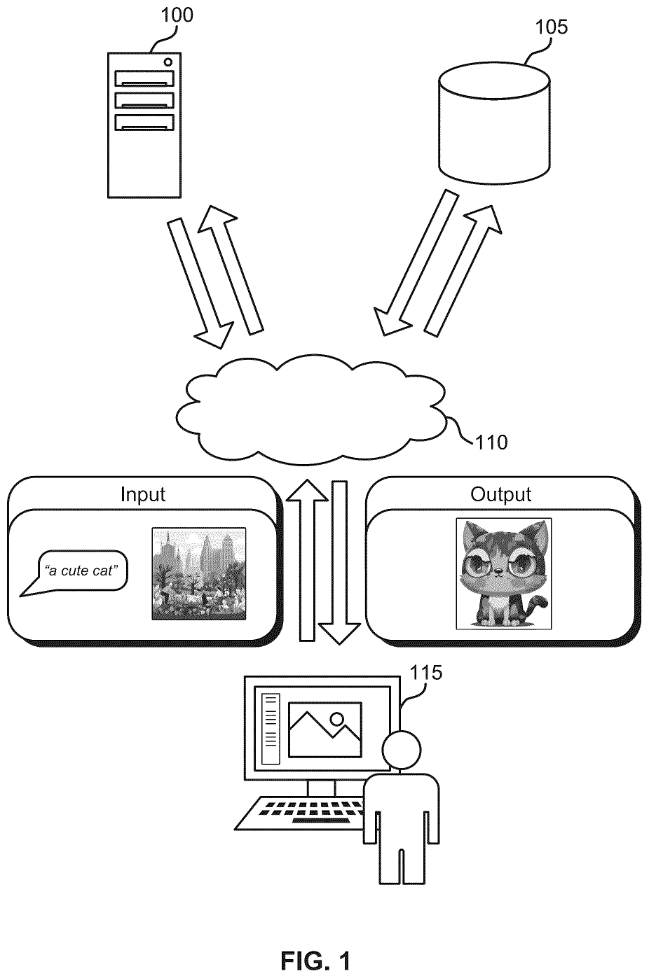

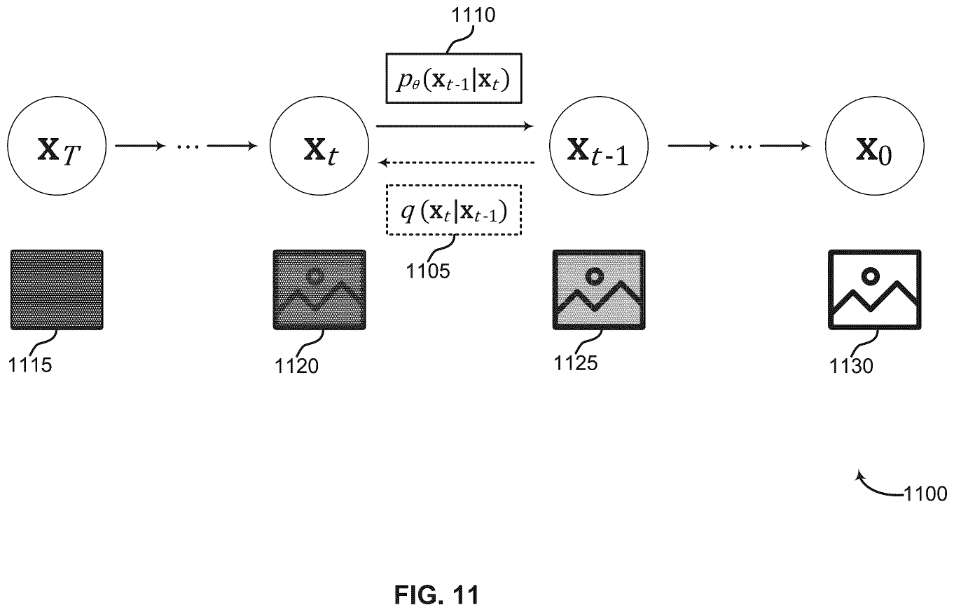

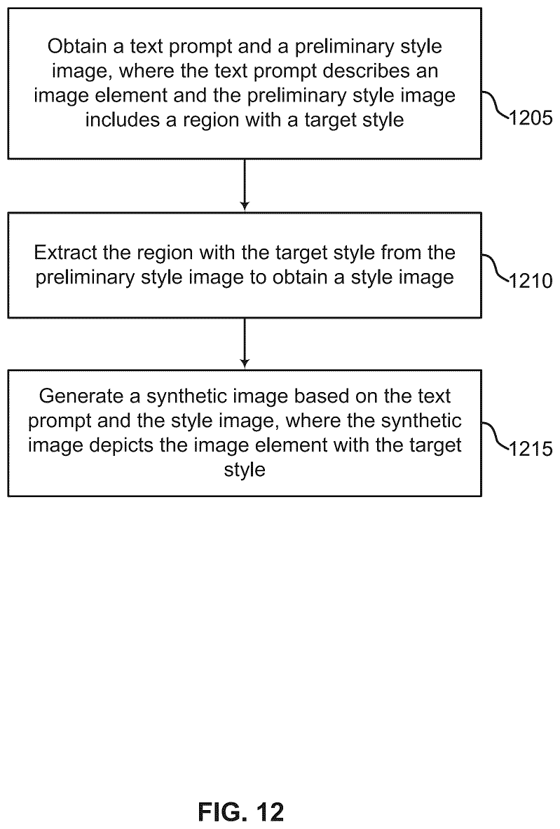

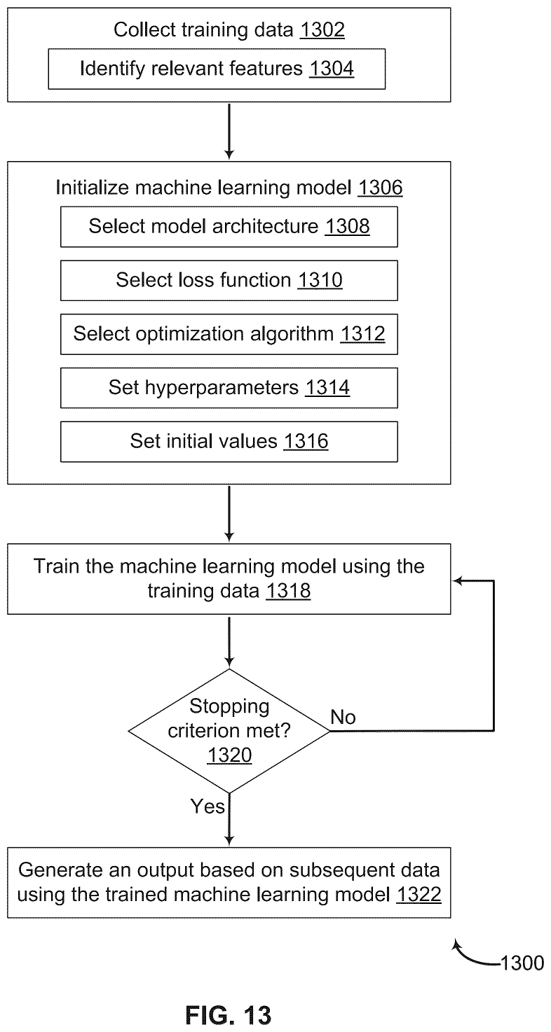

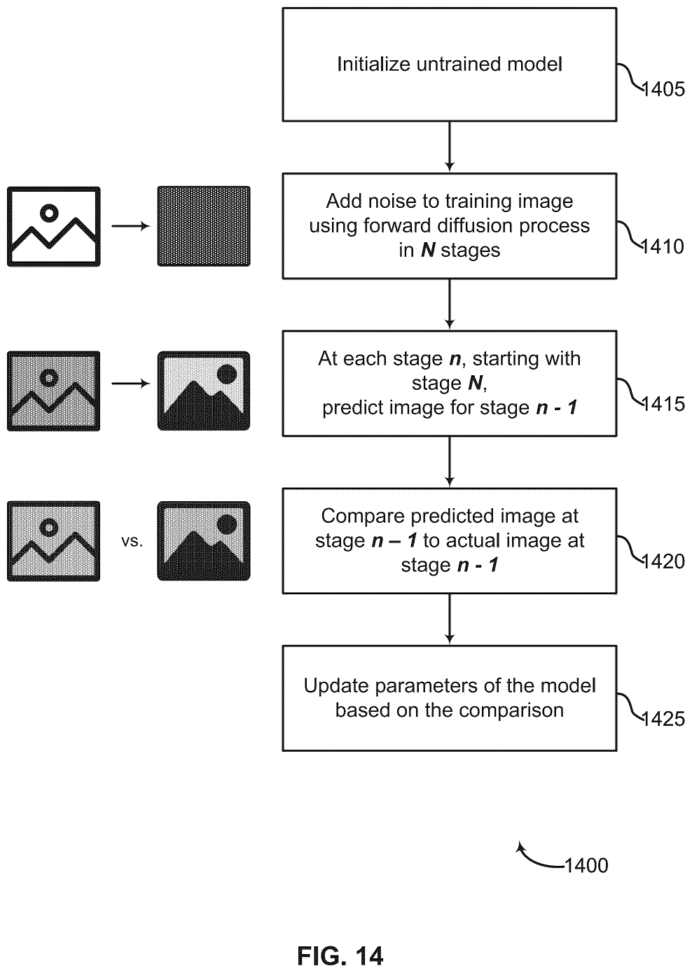

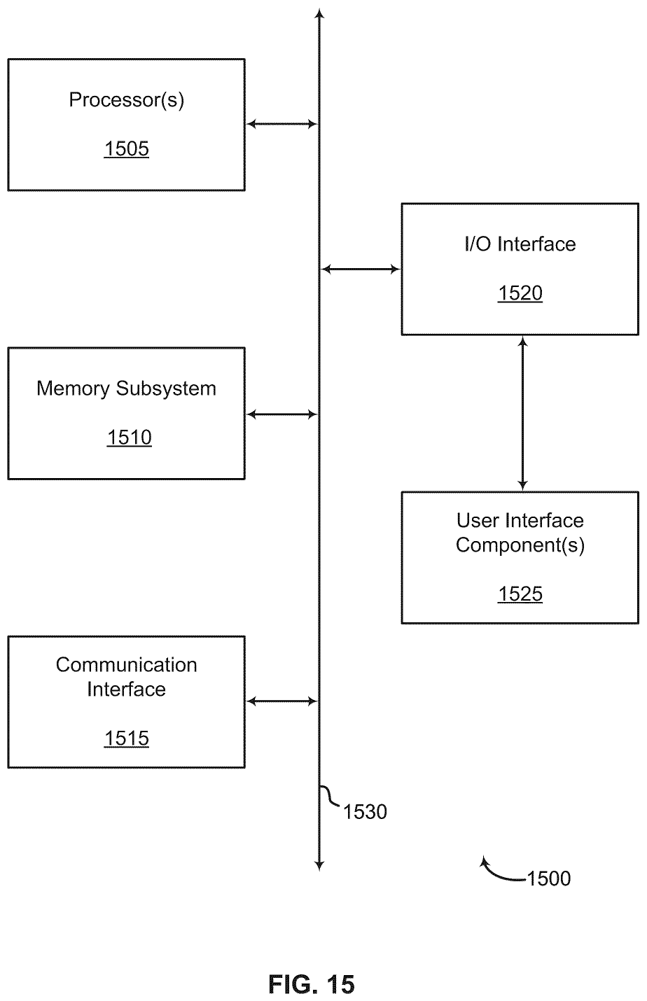

An image processing system is described with reference to FIGS. 1-10. Methods for generating synthetic images that are coherent with a scene are provided with reference to FIGS. 11-12. Training methods are described with reference to FIGS. 13-14. A computing device configured to implement an image processing apparatus is described with reference to FIG. 15.

### Image Processing System

FIG. 1 shows an example of an image processing system according to aspects of the present disclosure. The example shown includes image processing apparatus 100, database 105, cloud 110, and user interface 115.

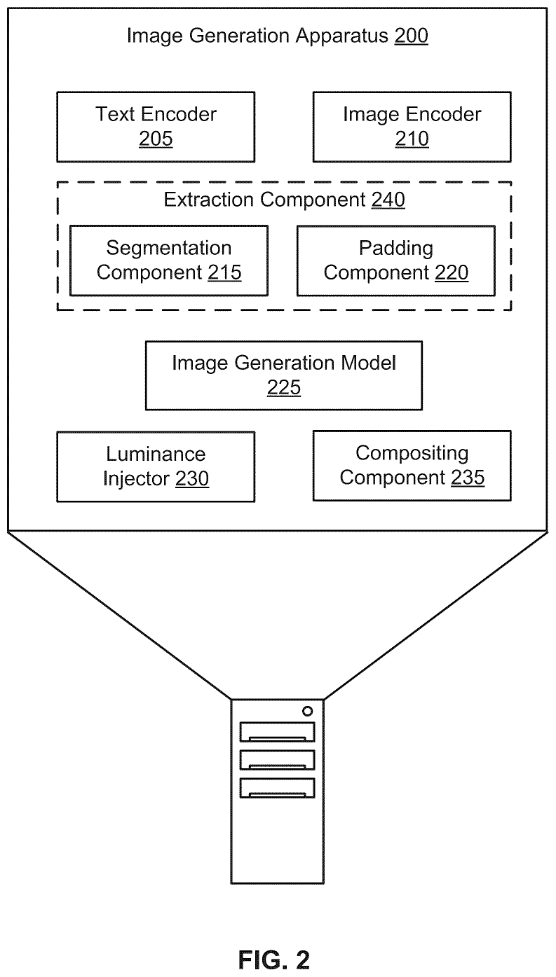

According to some aspects, image processing apparatus 100 obtains a text prompt and a preliminary style image, where the text prompt describes an image element and the preliminary style image includes a region with a target style. Image processing apparatus 100 is an example of, or includes aspects of, the corresponding element described with reference to FIG. 2.

In one example, a user provides a text prompt and a context image—sometimes referred to as a preliminary style image—via user interface 115. The text prompt includes a description of content the user wishes to generate, such as a character or an object. In the example shown, the text prompt is “a cute cat”, and the context image depicts a vector-style cityscape with nature elements. Then, an image processing apparatus processes the text prompt and the context image to generate text and image embeddings, and generates an output image using the text and image embeddings as conditioning. Some embodiments select a region of the context image, and then add a padding of a neutral color to this region to generate a style image, and the style image is processed to generate the image embedding used for conditioning. The output image (in this example, a cat including one or more stylistic elements from the style image) is then sent to the user via user interface 115.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 is configured to store information used by the image processing system. For example, database 105 may store reference images, previously generated images, machine learning model parameters, training data, and the like. A database is an organized collection of data. For example, a database stores data in a specified format known as a schema. A database may be structured as a single database a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and a user, e.g., via user interface 115. In some cases, network 110 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with the image processing apparatus 100. For example the user may enter a text prompt and provide a context image via user interface 115. In some embodiments, the user interface 115 may include an audio device, such as an external speaker system, an external display device such as a display screen, or an input device (e.g., remote control device interfaced with the user interface 115 directly or through an IO controller module). In some cases, a user interface 115 may be a graphical user interface 115 (GUI). For example, the GUI may be incorporated as part of a web application.

FIG. 2 shows an example of an image processing apparatus according to aspects of the present disclosure. The example shown includes image processing apparatus 200, text encoder 205, image encoder 210, an extraction component 240 including segmentation component 215 and padding component 220, image generation model 225, luminance injector 230, and compositing component 235.

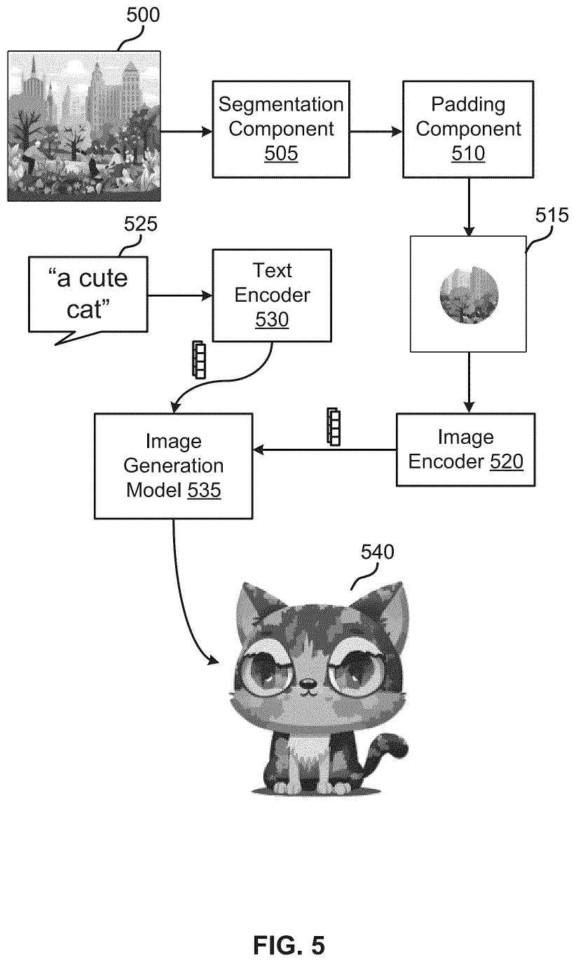

Image processing apparatus 200 is an example of, or includes aspects of, the corresponding element described with reference to FIG. 1. Text encoder 205, image encoder 210, segmentation component 215, padding component 220, and image generation model 225 are examples of, or include aspects of, the corresponding elements described with reference to FIG. 5.

Embodiments of image processing apparatus 200 include several components and sub-components. These components are variously named, and are described so as to partition the functionality enabled by the processor(s) and the executable instructions included in the computing device used to implement image processing apparatus 200 (such as the computing device described with reference to FIG. 15). The partitions may be implemented physically, such as through the use of separate circuits or processors for each component, or may be implemented logically via the architecture of the code executable by the processors.

Embodiments of image processing apparatus 200 include one or more artificial neural network(s) (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Text encoder 205 is configured to generate a text embedding, which a data-rich vector representation of text designed to capture semantic meaning, based on an input text prompt. Embodiments of text encoder 205 include a transformer based model, such as Flan-T5. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Image encoder 210 is configured to generate an image embedding from an input image. Embodiments of image encoder 210 include a convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input. In some embodiments, image encoder 210 is or is based on an image encoder from a pre-trained CLIP model. Similarly, text encoder 205 may be or be based on a text encoder from a pre-trained CLIP model. Some embodiments of image encoder 210 utilize a vision transformer model, which operates in a similar way to the text encoder, but processes patches of an image rather than words of a sentence.

Contrastive Language-Image Pre-Training (CLIP) is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The model can then output a linear classifier of CLIP's visual representations.

Extraction component 240 is configured to extract a style image from a context image. According to some aspects, extraction component 240 includes segmentation component 215 and padding component 220.

Segmentation component 215 is configured to identify region(s) of the context image. In some embodiments, segmentation component 215 identifies the region(s) on different bases. In some examples, segmentation component 215 computes a semantic similarity between the region of the context image and the text prompt, where the region of the context image is identified based on the semantic similarity. For example, segmentation component 215 may include a semantic segmentation component which includes an image encoder such as a CLIP image encoder. The semantic segmentation component may compute semantic embeddings for different regions of the image, and then select the region that is the most semantically similar to the text prompt, e.g., as determined by comparing the semantic embeddings with the text embedding.

Some embodiments of segmentation component 215 identify the region of the context image by computing a salience value for the region of the context image. For example, embodiments of segmentation component 215 include a saliency network which computes saliency scores for different patches (e.g., “regions”) of the context image, and then select a region with the highest saliency score.

After segmentation component 215 identifies a region of a context image, or the user identifies the region, padding component 220 alters the context image to produce a style image. According to some aspects, padding component 220 pads the region of the context image to obtain the style image. In some aspects, the padding the region of the context region includes adding a colorless background to the region of the context image. For example, the padding may include adding a white or black background such that a portion of the content of the context image remains in the center of the region, with the background color extending to the borders of the identified region. The portion may be circular, rectangular, or some other shape. The padding component, for example, may block out content of the region according to a mask. In some examples, padding component 220 obtains a mask for the region of the context image, where the mask corresponds to an element described by the text prompt.

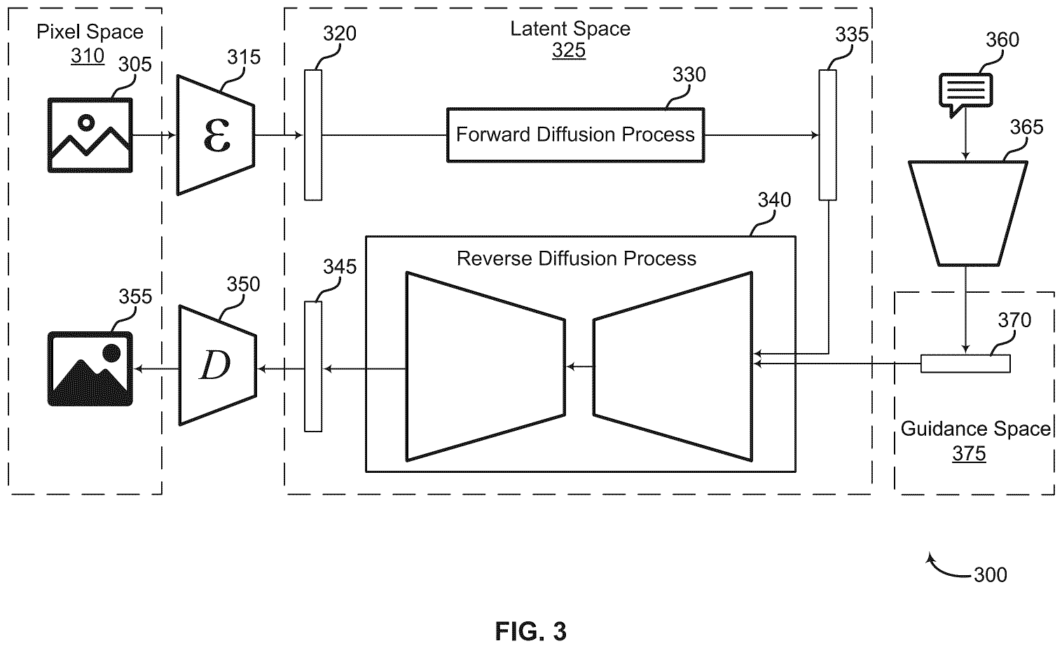

Image generation model 225 is configured to generate an output image based on a style image and text prompt. Embodiments of generation model 225 include a diffusion model configured to generate image content, though the present disclosure is not necessarily limited thereto. For example, some embodiments of generation model 225 include a generative adversarial network (GAN) based model. An example of a diffusion model will be described with reference to FIG. 3.

Luminance injector 230 is configured to alter the coloring of the style image such that the output image, which is generated based on the style image, is sufficiently contrasted with the content on which it is overlaid. In other words, luminance injector 230 alters the coloring of the style image such that the generated image stands out more when placed within the reference image.

In one embodiment, luminance injection is performed according to the following function:

$$Δ L = sgn ( ℒ ( R , G , B ) - 0.5 ) \frac{1}{2.5 - 0.8 ( 3 ) \vert ℒ ( R , G , B ) - 0.5 \vert} ∈ [ - 0 \text{.6} , - 0.4 ] ⋃ [ - 0.6 , - 0.4 ] \\ ℒ ( R , G , B ) = 0.2126 \cdot τ ( R ) + 0.715 \dot{2} \cdot τ ( G ) + 0.0 \; 722 \cdot τ ( B ) \qquad ( 1 )$$

where (R, G, B) represents the average color of the style image (e.g., the content of the style image without considering the padding) in the RGB color space, sgn is the sign function as given by

$$sgn ( x ) = \frac{\vert x \vert}{x} ,$$

and τ is given by:

$$τ ( K ) = \{ \begin{matrix}\frac{K}{12.92} , K \leq 0.03928 \\ {( \frac{K + 0.055}{1.055} )}^{2.4} , otherwise\end{matrix} \qquad ( 2 )$$

ΔL represents the amount of luminance that is injected into the style image. In some embodiments, if the luminance of the context image is high, then ΔL is reduced to obtain a generated output image with lower brightness and therefore higher contrast when integrated into the context image, and vice versa.

Some embodiments of luminance injector 230 inject a contrast color in addition to or alternatively from the luminance. In an example, the opposite color is calculated with the ΔE*CIELAB distance on the formulation of 2000 using a binary search algorithm on 3dimensions (R, G, and B). The contrast color injection increases the contrast of the output image when composited into the context image, and can also increase the chromatic variety of the output image, thereby increasing the detail of the content in the output image.

According to some aspects, compositing component 235 combines the synthetic image with the preliminary style image to obtain a combined image. In some examples, compositing component 235 identifies a location for inserting the synthetic image into the preliminary style image, where the luminance of the style image is modified based on the location. For example, the color processing as described with reference to Equations (1) and (2) may be made based on a portion of the context image corresponding to the location.

FIG. 3 shows an example of a guided latent diffusion model according to aspects of the present disclosure. The example shown includes guided latent diffusion model 300, original image 305, pixel space 310, image encoder 315, original image features 320, latent space 325, forward diffusion process 330, noisy features 335, reverse diffusion process 340, denoised image features 345, image decoder 350, output image 355, text prompt 360, text encoder 365, guidance features 370, and guidance space 375. According to some aspects, guided latent diffusion model 300 is an example of or is a component of the image generation model described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340. In some embodiments, an additional guidance may be encoded such as a style image, further contributing to guidance features 370.

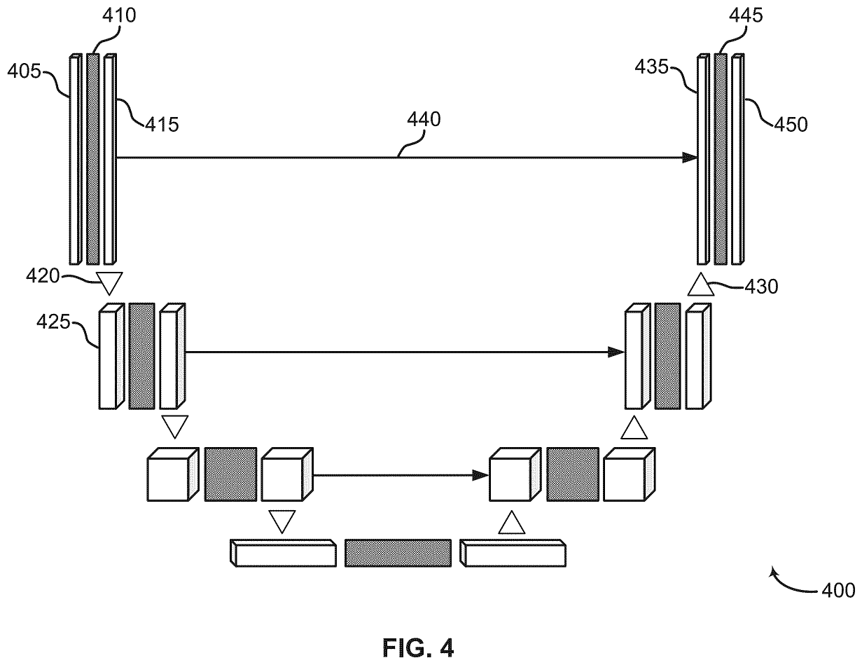

FIG. 4 shows an example of a U-Net 400 according to aspects of the present disclosure. In some examples, U-Net 400 is an example of the component that performs the reverse diffusion process 325 of guided diffusion model 300 described with reference to FIG. 3, and includes architectural elements of the image generation model 225 described with reference to FIG. 2. The U-Net 400 depicted in FIG. 4 is an example of, or includes aspects of, the architecture used within the reverse diffusion process described with reference to FIG. 3.

In some examples, diffusion models are based on a neural network architecture known as a U-Net. The U-Net 400 takes input features 405 having an initial resolution and an initial number of channels, and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having a same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of an image generation pipeline according to aspects of the present disclosure. The example shown includes preliminary style image 500, segmentation component 505, padding component 510, style image 515, image encoder 520, text prompt 525, text encoder 530, image generation model 535, and synthetic image 540. Segmentation component 505, padding component 510, image encoder 520, text encoder 530, and image generation model 555 are examples of, or include aspects of, the corresponding elements described with reference to FIG. 2.

In this example, a user provides preliminary style image 500 and text prompt 525. Text prompt 525 may be processed as-is by text encoder 530 to generate a text embedding. Embodiments may apply additional preprocessing to preliminary style image 500 to produce style image 515. For example, a segmentation component 505 may identify a region of preliminary style image 500 using the semantic segmentation or saliency segmentation methods described with reference to FIG. 2, or a user may specify the region via a user interface. Then, padding component 510 may add a background color to the region leaving a portion of the content in the center of the region, e.g., as indicated by the circular mask in style image 515.

Then, image encoder 520 processes style image 515 to produce an image embedding. The text embedding and the image embedding are then input to image generation model 535, which generates synthetic image 540 using the text embedding and the image embedding as a condition for the generation process. Additional detail regarding conditional generation is described with reference to the guided latent diffusion model of FIG. 3.

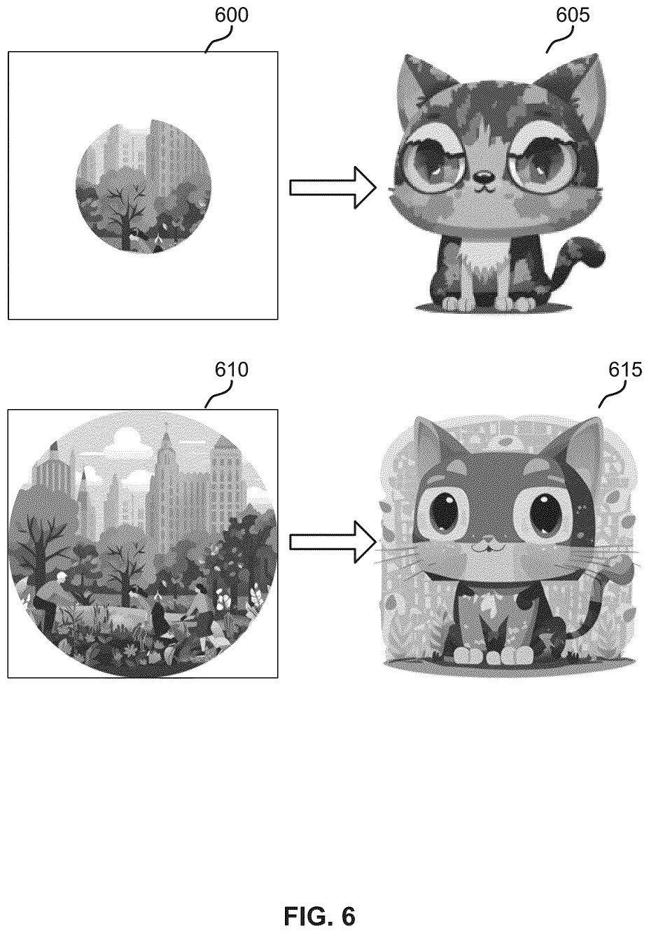

FIG. 6 shows an example of effects of different padding on image generation according to aspects of the present disclosure. The example shown includes larger padding style image 600, first synthetic image 605, less padding style image 610, and second synthetic image 615.

According to some aspects, a padding component such as one described with reference to FIGS. 2 and 5 adds padding to an identified region of a context image to produce a style image. In one example, the padding component adds a first amount of padding to produce larger padding style image 600, which is used as conditioning to an image generation model to produce first synthetic image 605. The image generation model may also be conditioned with a text prompt “a cute cat”. As shown in the Figure, first synthetic image 605 includes a cat with stylistic elements from the context image, but without additional scenic elements or objects in the background of the cat. Accordingly, first synthetic image 605 may be composited into a project without the additional processing to remove background objects.

If minimal to no padding is added, such as in less padding style image 610, an image generation model may produce second synthetic image 615. Second synthetic image 615 includes many additional scenic elements, including plants, designs, and solid colors disposed behind the cat. In some cases, inserting the second synthetic image 615 into a design may not be cohesive with the design, as the background elements may not fit or make sense in the context of the rest of the image. Conventional systems do not select a sub-region of a context image, or pad the region, and can therefore generate synthetic images that aren't cohesive in a larger design such as second synthetic image 615.

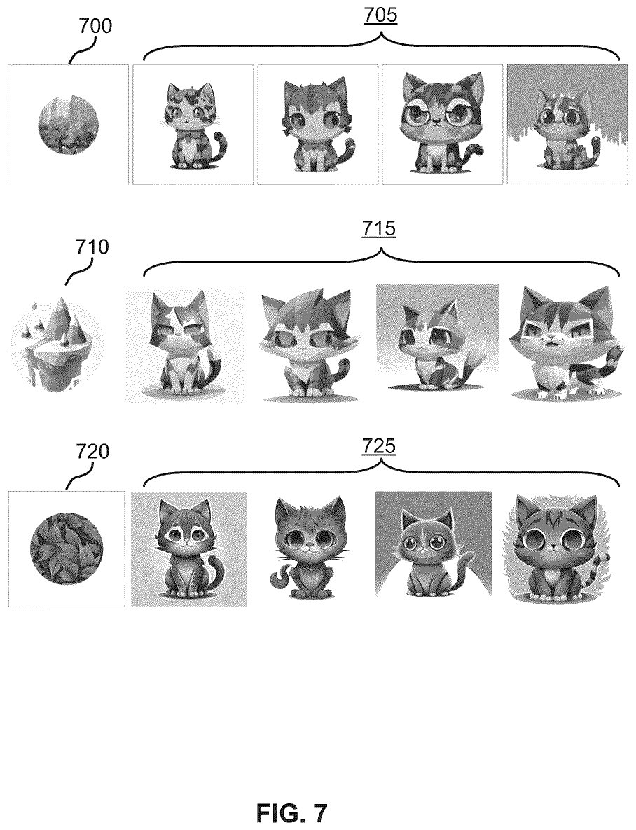

FIG. 7 shows an example of results of different style images combined with the same text prompt according to aspects of the present disclosure. The example shown includes first style image 700, first synthetic images 705, second style image 710, second synthetic images 715, third style image 720, and third synthetic images 725. The 2^{nd} through 5^{th} columns, that is, first synthetic images 705, second synthetic images 715, and third synthetic images 725, are repeated generations (e.g., with different generation seeds) based on conditioning from an embedding of the style image, and on conditioning from an embedding of a text prompt “a cute cat.”

As shown in the Figure, different amounts of padding may be appropriate for different context images. For example, the second row shows second style image 710 depicting mountains suspended on a floating island. Since this context image already has a large area of neutral background, a relatively small amount of padding is applied when creating the style image used for the image generation process. In contrast, the first row includes first style image 700 depicting a cityscape, which, before padding, includes very little neutral background and many scenic elements. Accordingly, a larger amount of padding is appropriate to produce first synthetic images 705 that do not include extraneous scene elements. Some embodiments include a detail measuring component (e.g., as part of a padding component) configured to process the identified region of the context image to compute a measure of detail in the region, and then select an amount of padding according to the computed measure of detail. For example, the detail measuring component may use computer vision techniques such as edge detection, Local Binary Patterns (LBP), entropy measurements, or trained ANN-based image encoders to quantify the amount of detail in a region of the context image, and base the amount of padding used on the region on the measured detail.

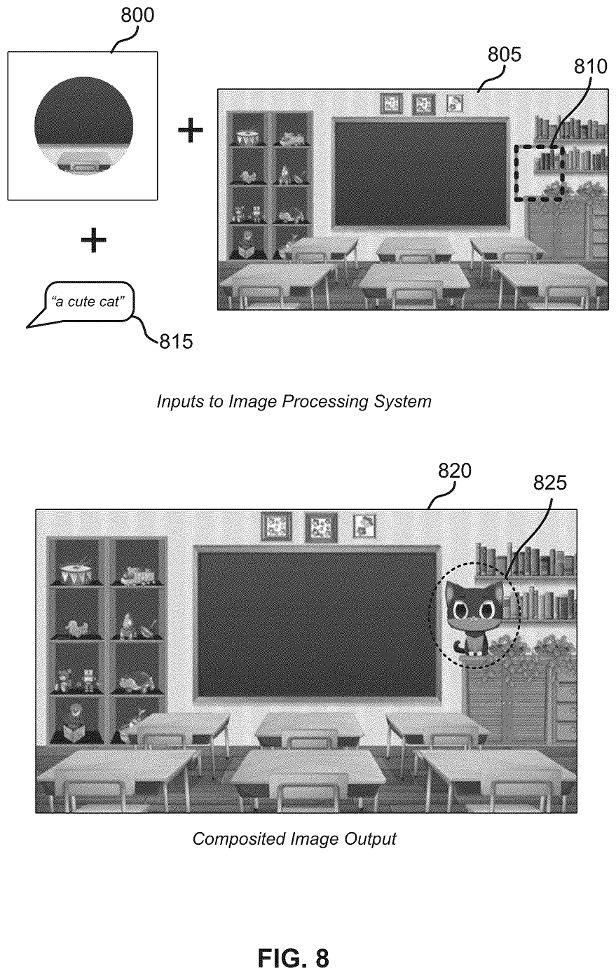

FIG. 8 shows an example of synthetic image 825 placement according to aspects of the present disclosure. The example shown includes style image 800, preliminary style image 805, text prompt 815, and composited image 820.

In this example, a user provides preliminary style image 805 depicting a vector-styled classroom setting. The user may specify a region of the preliminary style image 805 to be used in creating style image 800, or the system may automatically select the region based on the processes described with reference to FIGS. 2 and 5. The system may add padding to this region to produce style image 800, and encode the style image as well as text prompt 815 “a cute cat” to yield image and text embeddings, respectively. The system then generates synthetic image 825 based on style image 800 and text prompt 815. The system further identifies placement location 810 to place synthetic image 825, and places the synthetic image 825 to produce composited image 820. Additionally or alternatively, the user may identify placement location 810 for placing the synthetic image.

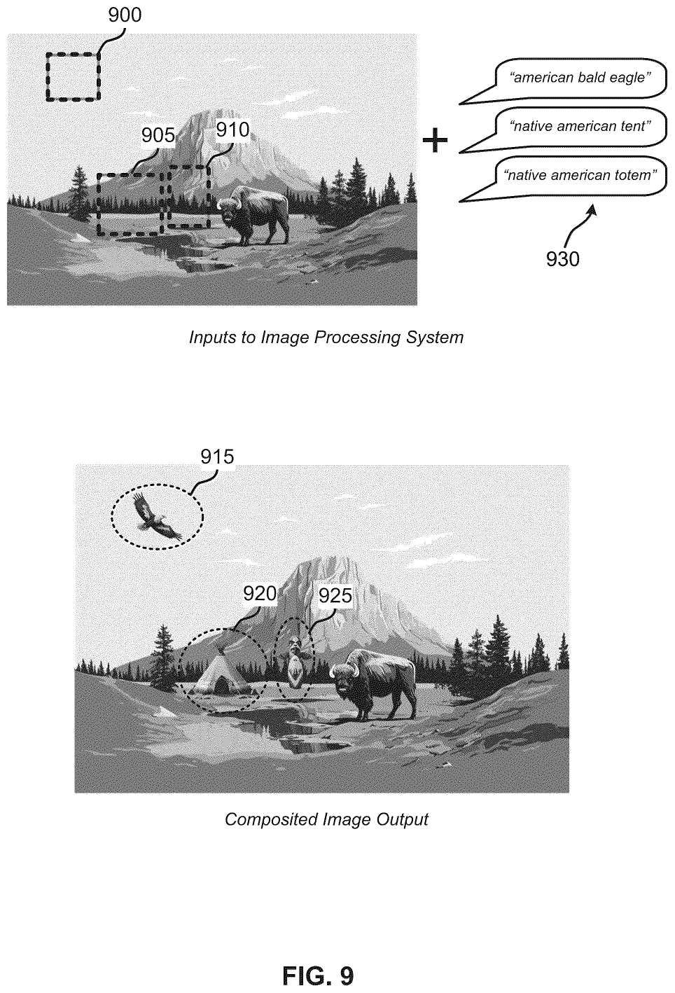

FIG. 9 shows an example of placing multiple objects in a scene according to aspects of the present disclosure. The example shown includes first location 900, second location 905, third location 910, first object 915, second object 920, third object 925, and text prompts 930.

In this example, a user may specify first location 900, second location 905, and third location 910, or the system may automatically determine first location 900, second location 905, and third location 910 using the methods described above. The user may provide text prompts 930 for each of first location 900, second location 905, and third location 910, such as “American bald eagle”, “native American tent”, and “native American totem”. The system then generates synthetic images based on first location 900, second location 905, and third location 910 and the three text prompts, where the synthetic images include first object 915, second object 920, and third object 925. The system may transfer stylistic elements from first location 900, second location 905, and third location 910 to first object 915, second object 920, and third object 925, respectively, during the generation process. According to some aspects, the system also performs luminance injection on the intermediate style images created from first location 900, second location 905, and third location 910 so that first object 915, second object 920, and third object 925 have sufficient contrast with the context image.

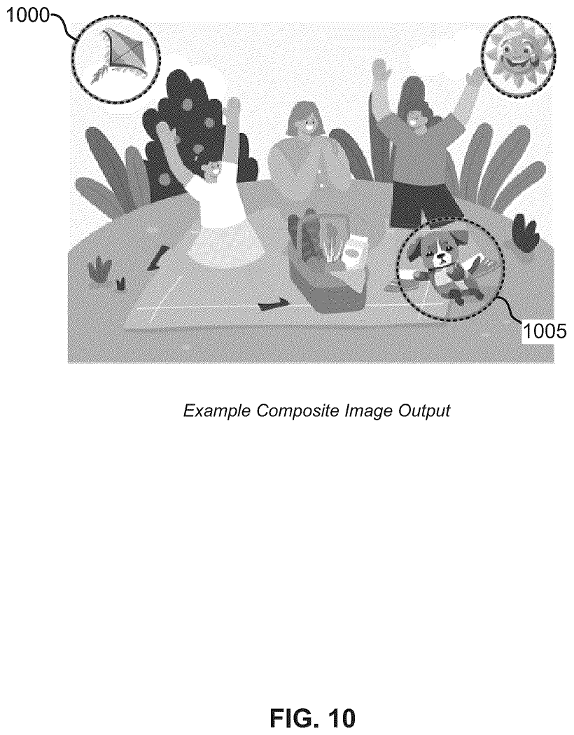

FIG. 10 shows an example of additional object placements according to aspects of the present disclosure. The example shown includes high contrast object 1000 and low contrast object 1005.

According to some aspects, the objects are each generated by an image generation model, where the generation is conditioned such that the objects don't include additional background elements and are therefore suitable for placement in context images without further processing. Some embodiments are further configured to vectorize the combined images to increase their editability.

In this example, the system identifies a region that is semantically similar to a text prompt “kite.” This region is determined to have high contrast with the generated high contrast object 1000, and therefore, the system does not apply additional luminance injection to high contrast object 1000. In contrast, the system identifies a second region that is semantically similar to “picnic dog”; in this case, the region is determined to have relatively low contrast with low contrast object 1005. Accordingly, the system applies luminance injection operations to increase the contrast of low contrast object 1005 with its surroundings. Additional detail regarding the luminance injection operations is provided with reference to FIG. 2.

### Generating Images Using Style Images

FIG. 11 shows a diffusion process 1100 according to aspects of the present disclosure. In some examples, diffusion process 1100 describes an operation of the image generation model described with reference to FIG. 2, such as the reverse diffusion process 340 of guided diffusion model 300 described with reference to FIG. 3.

As described above with reference to FIG. 3, using a diffusion model can involve both a forward diffusion process 1105 for adding noise to an image (or features in a latent space) and a reverse diffusion process 1110 for denoising the images (or features) to obtain a denoised image. The forward diffusion process 1105 can be represented as q(xₜ|xₜ₋₁), and the reverse diffusion process 1110 can be represented as p (xₜ₋₁|xₜ). In some cases, the forward diffusion process 1105 is used during training to generate images with successively greater noise, and a neural network is trained to perform the reverse diffusion process 1110 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q (x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1110, the model begins with noisy data x_{T}, such as a noisy image 1115 and denoises the data to obtain the p (xₜ₋₁|xₜ). At each step t−1, the reverse diffusion process 1110 takes xₜ, such as first intermediate image 1120, and t as input. Here, t represents a step in the sequence of transitions associated with different noise levels, The reverse diffusion process 1110 outputs xₜ₋₁, such as second intermediate image 1125 iteratively until x_{T} reverts back to x₀, the original image 1130. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} )$$

where p(x_{T})=N(x_{T}; 0,I) is the pure noise distribution as the reverse process takes the outcome of the forward process, a sample of pure noise, as input and Πₜ₌₁ ^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

FIG. 12 shows an example of a method 1200 for generating synthetic images that are coherent with a preliminary style image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains a text prompt and a preliminary style image, where the text prompt describes an image element and the preliminary style image includes a region with a target style. In some cases, the operations of this step refer to, or may be performed by, an image processing apparatus as described with reference to FIGS. 1 and 2. For example, a user may input the text prompt and the preliminary style image via a user interface as described with reference to FIG. 1. The preliminary style image may be, for example, a scene image that is a part of a design document within a multi-layer document editing software.

At operation 1210, the system extracts the region with the target style from the preliminary style image to obtain a style image. In some cases, the operations of this step refer to, or may be performed by, a segmentation component as described with reference to FIGS. 2 and 5. For example, the segmentation component may use a saliency network to determine which region(s) of the preliminary style image are most appropriate for extracting a style in consideration of the text prompt. In some cases, the segmentation component computes semantic similarity scores for different regions of the preliminary style image with an embedding of the text prompt, and then chooses the region based on the semantic similarity score. The system may further pad the style image to mask out edge content and preserve content in the center.

At operation 1215, the system generates, using an image generation model, a synthetic image based on the text prompt and the style image, where the synthetic image depicts the image element with the target style. In some cases, the operations of this step refer to, or may be performed by, an image generation model as described with reference to FIGS. 2 and 5. For example, the image generation model may generate the synthetic image by performing a reverse diffusion process that is conditioned on features from a text embedding of the text prompt and an image embedding of the style image. Additional detail regarding this generation process is provided with reference to FIGS. 3 and 11.

FIG. 13 is a flow diagram depicting an algorithm as a step-by-step procedure 1300 in an example implementation of operations performable for training a machine-learning model. In some embodiments, the procedure 1300 describes an operation of a training component used for configuring the image generation model 225 described with reference to FIG. 2. The procedure 1300 provides one or more examples of generating training data, use of the training data to train a machine-learning model, and use of the trained machine-learning model to perform a task.

To begin in this example, a machine-learning system collects training data (block 1302) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1304) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1306). Initialization of the machine-learning model includes selecting a model architecture (block 1308) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1310). The loss function is utilized to measure a difference between an output of the machine-learning model (i.e., predictions) and target values (e.g., as expressed by the training data) to be used to train the machine-learning model. Additionally, an optimization algorithm is selected (1312) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1314) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1318) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1320), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1320), the procedure 1300 continues training of the machine-learning model using the training data (block 1318) in this example.

If the stopping criterion is met (“yes” from decision block 1320), the trained machine-learning model is then utilized to generate an output based on subsequent data (block 1322). The trained machine-learning model, for instance, is trained to perform a task as described above and therefore once trained is configured to perform that task based on subsequent data received as an input and processed by the machine-learning model.

FIG. 14 shows an example of a method 1400 for training a diffusion model according to aspects of the present disclosure. In some embodiments, the method 1400 describes an operation a training component that is used for configuring the image generation model 225 as described with reference to FIG. 2. Embodiments of the image generation model described herein are “finetuned” (e.g., an adjustment training process after a pretraining phase) on vector-style images, so as to be inclined to generate images that are also vector-style. Accordingly, such images are said to be “vectorizable”; that is, include attributes that enable vectorization operations. Such attributes include but are not limited to: minimal gradients, flat colors, clear lines, simple shapes, and minimal high-frequency detail. Easily vectorizable images result in vector-formatted images after conversion that have a minimal number of paths and shapes. The method 1400 represents an example for training a reverse diffusion process as described above with reference to FIGS. 3-4 and 11. In some examples, these operations are performed by a system including a processor executing a set of codes to control functional elements of an apparatus, such as the guided diffusion model described in FIG. 3.

Additionally or alternatively, certain processes of method 1400 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1405, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1410, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1415, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1420, the system compares predicted image (or image features) at stage n−1 to an actual image (or image features), such as the image at stage n−1 or the original input image. For example, given observed data x, the diffusion model may be trained to minimize the variational upper bound of the negative log-likelihood −logp_{θ}(x) of the training data.

At operation 1425, the system updates parameters of the model based on the comparison. For example, parameters of a U-Net may be updated using gradient descent. Time-dependent parameters of the Gaussian transitions can also be learned.

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, an image processing apparatus as described in FIGS. 1 and 2. In some embodiments, computing device 1500 includes one or more processors 1505 are configured to execute instructions stored in memory subsystem 1510 to obtain a text prompt and a preliminary style image, wherein the text prompt describes an image element and the preliminary style image includes a region with a target style; extract the region with the target style from the preliminary style image to obtain a style image; and generate, using an image generation model, a synthetic image based on the text prompt and the style image, wherein the synthetic image depicts the image element with the target style.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote control device interfaced with a user interface directly or through the I/O controller), or a combination thereof. In some cases, user interface component(s) 1525 include a GUI.

Accordingly, the present disclosure includes the following aspects.

A method for image generation is described. One or more aspects of the method include obtaining a text prompt and a preliminary style image, wherein the text prompt describes an image element and the preliminary style image includes a region with a target style; extracting the region with the target style from the preliminary style image to obtain a style image; and generating, using an image generation model, a synthetic image based on the text prompt and the style image, wherein the synthetic image depicts the image element with the target style.

Some examples of the method, apparatus, non-transitory computer readable medium, and system further include applying padding to a background region of the preliminary style image. Some examples further include obtaining a mask indicating the region with the target style. Some examples further include applying the mask to the preliminary style image.

Some examples of the method, apparatus, non-transitory computer readable medium, and system further include computing a semantic similarity between the region and the text prompt, wherein the region is identified based on the semantic similarity. Some examples further include computing a salience value for the region of the preliminary style image, wherein the region of the preliminary style image is identified based on the salience value. Some examples further include combining the synthetic image with the preliminary style image to obtain a combined image.

Some examples of the method, apparatus, non-transitory computer readable medium, and system further include modifying a luminance of the style image to obtain a modified style image, wherein the synthetic image is generated based on the modified style image. Some examples further include identifying a location for inserting the synthetic image into the preliminary style image, wherein the luminance of the style image is modified based on the location.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a text prompt and a preliminary style image, wherein the text prompt describes an image element and the preliminary style image includes a region with a target style;
extracting the region with the target style from the preliminary style image to obtain a style image; and
generating, using an image generation model, a synthetic image based on the text prompt and the style image, wherein the synthetic image depicts the image element with the target style.

2. The method of claim 1, wherein extracting the region comprises:
applying padding to a background region of the preliminary style image.

3. The method of claim 1, wherein extracting the region comprises:
obtaining a mask indicating the region with the target style; and
applying the mask to the preliminary style image.

4. The method of claim 1, wherein extracting the region comprises:
computing a semantic similarity between the region and the text prompt, wherein the region is identified based on the semantic similarity.

5. The method of claim 1, wherein extracting the region comprises:
computing a salience value for the region of the preliminary style image, wherein the region of the preliminary style image is identified based on the salience value.

6. The method of claim 1, further comprising:
combining the synthetic image with the preliminary style image to obtain a combined image.

7. The method of claim 1, further comprising:
modifying a luminance of the style image to obtain a modified style image, wherein the synthetic image is generated based on the modified style image.

8. The method of claim 7, further comprising:
identifying a location for inserting the synthetic image into the preliminary style image, wherein the luminance of the style image is modified based on the location.

9. A non-transitory computer readable medium storing code for image processing, the code comprising instructions executable by a processor to perform operations comprising:
obtaining a text prompt and a preliminary style image, wherein the text prompt describes an image element and the preliminary style image includes a region with a target style;
extracting the region with the target style from the preliminary style image to obtain a style image; and
generating, using an image generation model, a synthetic image based on the text prompt and the style image, wherein the synthetic image depicts the image element with the target style.

10. The non-transitory computer readable medium of claim 9, the code further comprising instructions executable by the processor to perform operations comprising:
applying padding to a background region of the preliminary style image.

11. The non-transitory computer readable medium of claim 9, the code further comprising instructions executable by the processor to perform operations comprising:
obtaining a mask indicating the region with the target style; and
applying the mask to the preliminary style image.

12. The non-transitory computer readable medium of claim 9, the code further comprising instructions executable by the processor to perform operations comprising:
computing a semantic similarity between the region and the text prompt, wherein the region is identified based on the semantic similarity.

13. The non-transitory computer readable medium of claim 9, the code further comprising instructions executable by the processor to perform operations comprising:
computing a salience value for the region of the preliminary style image, wherein the region of the preliminary style image is identified based on the salience value.

14. The non-transitory computer readable medium of claim 9, the code further comprising instructions executable by the processor to perform operations comprising:
modifying a luminance of the style image to obtain a modified style image, wherein the synthetic image is generated based on the modified style image.

15. An apparatus comprising:
a memory component;
a processing device coupled to the memory component;
an extraction component comprising parameters stored in the memory component and configured to extract a region with a target style from a preliminary style image to obtain a style image; and
an image generation model comprising parameters stored in the memory component and trained to generate a synthetic image based on a text prompt and the style image, wherein the synthetic image depicts an image element from the text prompt with the target style.

16. The apparatus of claim 15, wherein the extraction component comprises:
a padding component configured to apply padding to a background region of the preliminary style image.

17. The apparatus of claim 1, wherein the extraction component is further configured to:
obtain a mask indicating the region with the target style; and
apply the mask to the preliminary style image.

18. The apparatus of claim 15, wherein the extraction component comprises:
a segmentation component configured to compute a semantic similarity between the region and the text prompt, wherein the region is identified based on the semantic similarity.

19. The apparatus of claim 15, wherein the extraction component is further configured to:
compute a salience value for the region of the preliminary style image, wherein the region of the preliminary style image is identified based on the salience value.

20. The apparatus of claim 15, further comprising:
a luminance injector configured to modify a luminance of the style image to obtain a modified style image, wherein the synthetic image is generated based on the modified style image.
